(19) United States
(12) Patent Application Publication
(10) Pub. No.: US 2006/0260161 A1
(43) Pub. Date: Nov. 23, 2006

(54) Illuminated Signage With a Means for Storing and Transferring Data

(76) Inventor: Keith Hamilton, Littleton, CO (US)

Correspondence Address: SHERIDAN ROSS PC, 1560 BROADWAY, SUITE 1200, DENVER, CO, 80202, US

(21) Appl. No.: 11/419,973

(22) Filed: May 23, 2006

Related U.S. Application Data
(60) Provisional application No. 60/684,148, filed on May 23, 2005.

(51) Int. Cl. G09F 13/00

(52) U.S. Cl. 40/541

(57) ABSTRACT

An illuminated, solar powered sign is provided which in one embodiment includes a memory storage device which can be accessed with an electronics device such as a flash card, laptop computer, PDA, cellphone or other similar apparatus. Alternatively the stored data can be transmitted wirelessly to an electronics device where information related to the sale of real estate or other commodities can be reviewed.

The present application claims the benefit of pending U.S. Provisional Patent Application Ser. No. 60/684,148 having a filing date of May 23, 2005. the application being incorporated by reference in its entirety herein.

### FIELD OF THE INVENTION

The present invention relates to signage, and more specifically solar powered illuminated signs which store and transmit data related to a sale or transaction.

### BACKGROUND OF INVENTION

Current advertising signs, such as real estate signs, have not changed much since there inception. They are hard to see after dark and contain only the amount of information that can be printed on the sign's surface or supplemental flyers attached to it.

Conventional signs typically contain only a small number of flyers and typically are depleted real estate agents can refill the containers. Too often these flyers end up littering the front of the business or yard of the home for which they are meant to be promoting. If there is a flyer left to look at, there is never sufficient room for pictures or text to give perspective patron/buyers enough information about the product. This lack of information leads to more frequent calls to the business or real estate agent and more frustration for both parties.

To retrieve these flyers one must get out of the car and walk on the sellers property. This is especially a problem when it comes to real estate signage. This often makes people feel like trespassers even though this is the standard procedure. If the seller is home the scenario can become even more awkward.

Another huge problem is sign theft. Signs are easily stolen with no alarm system or deterrent. With each sign costing anywhere from $75 and more, a loss of these signs can quickly add up to significant financial loss. The signs are easy prey in residential neighborhoods, especially after dark.

With today's busy lifestyles, perspective buyers often have to look for prospective new homes in the evening or after dark. This presents an even bigger problem in the winter when the days are short. Pulling up to an intersection there is no way to see which houses are for sale on the cross streets. Running an extension cord to light up a sign is further cumbersome, costly, and pose certain safety issues.

Batteries drain quickly and have to be replaced frequently. Thus there are periods of time when the sign would be dark after the batteries are depleted and before they could be replaced. Further, there is a negative ecological impact of going through large quantities of batteries.

For the above stated reasons, it is advantageous to provide an illuminated sign powered by renewable energy that further contains downloadable information which could be selectively retrieved. In particular, it would be advantageous to down load this information directly from the sign to a PDA, laptop computer or similar electronic device, or alternatively transmit the information wirelessly. In addition, it would be advantageous if this sign included an alarm that would go off if it were pulled out of the ground or tampered with by an unauthorized person, included a dimmer control switch to alter the amount of illumination and included a motion sensor to activate a prerecorded message.

### SUMMARY OF THE INVENTION

Thus, it is one aspect of the present invention to provide improvements to currently available signs. In one embodiment, the present invention entails a portable sign that may be illuminated through the use of a solar panel and LEDs within the body of the sign. The LEDs or conventional light bulbs can be a multitude of sizes and an unlimited number can be used. The LEDs can maintain constant light or flash in different patterns. The solar panel or panels that power the sign can be either flexible or rigid and attached directly to the sign or the frame that holds the sign. Further, the lights can be positioned within the cavity of the sign or on an exterior portion.

Another embodiment of the present invention includes a timer can be attached to or contained within the sign so the power and lighting can be turned off at certain times of the day or night if needed. Thus the illuminated sign can be used in neighborhoods with strict covenants.

Another aspect of the present invention includes a greeting or warning which can be activated by voice or motion detection. This activation may invoke a audible greeting from the sign and/or a change in light patterns, or provide instructions how to download valuable information.

Another aspect of the present invention includes an alarm which can be triggered if the sign is removed from the ground or tampered with. The alarm may be audible and/or involve a change in light patterns or both, and may be activated by a vibration sensor device.

Another aspect of the present invention allows the capability for information to be downloaded onto a memory stick or other storage device directly from the sign and from there subsequently downloaded onto a computer through a USB port or onto any PDA, cell phone, lap top computer or other similar electronic device. The information from multiple signs could be downloaded onto one memory stick to be viewed later. These downloads could activate a specific website associated with the sign or sign's specific geographic areas or other pertinent data. The patrons could then view specific information about the product they were interested in more detail. For example, if the information was obtained from a real estate sign, detailed information about a specific home, building, or land may be provided. Companies that have products relevant to the downloaded product or real estate may buy advertising on the website that is provided when pertinent.

Another aspect of the present invention is that the information contained on the hard drive of the sign can be downloaded through a wireless connection onto a laptop computer, PDA or cell phone. This would allow the recipient to receive the information without leaving their vehicle.

Another aspect of the present invention is that all of the above aspects could be part of a new sign or adapted to fit into the frame of a preexisting real estate sign. It could also be adapted to a sign that was partially new and partially preexisting. Many different types of frames may be used to hold the sign and it's components.

A further aspect of the present invention is that the memory storage device is programmable. The owner of the sign can program the necessary information into the hard drive within the sign and can reprogram the hard drive or microchip when it is moved to another location or additional information becomes available or if the sign is used in a new location. Thus, it can be reprogrammed to advertise another product, piece of real estate or business, or to include additional information which was not previously available.

Thus, in one aspect of the present invention, a portable, solar powered illuminated sign is provided, comprising:

a sign comprising a front surface operably interconnected to a rear surface and defining a space therebetween at least any of said front and rear surfaces adapted for displaying indicia;

a frame operably interconnected to said sign;

a solar panel operably interconnected to at least one of a said sign and said frame which converts solar energy to electrical energy;

a battery in operable communication with said solar panel;

at least one illuminating device positioned in said space and which is in operable communication with said solar panel; and

a memory storage device which is in operable connection with said battery which is comprised of storing data.

It is a further aspect of the present invention to provide a method for providing information from a portable sign. This may be used with or without an illuminated sign. More specifically, the method may comprise:

providing a sign operably interconnected to a frame;

illuminating said sign when the amount of ambient light falls below a predetermined level;

providing a data storage device which is operably interconnected to at least one of the sign and said frame;

storing predetermined data on said data storage device;

providing a port operably interconnected to said data storage device which is adapted to receive a data transfer device; and

transferring said predetermined data to said data storage device upon insertion of said data transfer device into said port.

### BRIEF DESCRIPTION OF THE DRAWINGS

FIG. 1 is a front perspective view of an illuminated sign depicting one embodiment of the present invention;

FIG. 2 is a exploded front perspective view of the sign shown in FIG. 1 with the frame removed for clarity;

FIG. 3 is a rear perspective view of the solar panel housing and further depicting other embodiments of the present invention including a speaker, light timer, and battery pack;

FIG. 4 is a front perspective view of the solar panel frame and solar panel;

FIG. 5 is a front perspective view of a memory card or chip and including a male connector;

FIG. 6 is a front perspective view of a solar panel and integral hard drive with access port;

FIG. 7 is a front perspective view of an illuminated sign, solar panel, memory card and electronic device for interconnection to a memory card or electronics device;

FIG. 8 is a front perspective view of the invention depicting the illuminated for sale sign, and flexible solar panel positioned on a portion of the transparent front panel; and

FIG. 9 is a front perspective view of one embodiment of the present invention wherein the transparent front panel has been removed to show additional detail of the componentry positioned within the sign.

To assist in the understanding of the present invention the following list of components and associated numbering found in the drawings is provided herein:

| Component | # |
|---|---|
| Illuminated sign | 2 |
| Solar panel | 4 |
| Frame | 6 |
| Transparent rear panel | 8 |
| Transparent front panel | 10 |
| Light bulb | 12 |
| Wiring harness | 14 |
| Speaker | 16 |
| Light timer | 18 |
| Mounting post | 20 |
| Batteries | 22 |
| Solar panel frame | 24 |
| Memory card or chip | 26 |
| Access port | 28 |
| Motion sensor | 30 |
| Wireless transmitter | 32 |
| Flexible solar panel strip | 34 |
| Notebook computer or handheld PC | 36 |
| Battery housing | 38 |
| Attachment hardware | 40 |
| Sign indicia | 42 |
| Sign internal cavity | 44 |
| Vibration/Anti-tampering sensor | 46 |
| Electrical conduit | 48 |
| Male connector | 50 |
| Microchip or computer hard drive | 52 |

### DETAILED DESCRIPTION

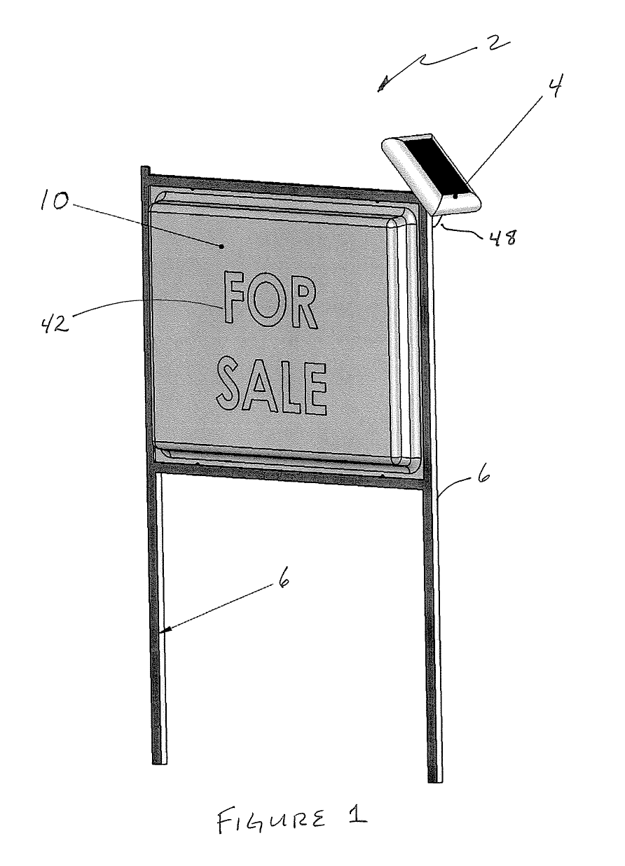

Referring now to the drawings, FIG. 1-9 depict various embodiments of the present invention. More specifically, the invention relates to signage and more specifically in one embodiment an illuminated sign which can be used for the purposes of selling real estate and any other conceivable product and which also could be used for restaurants, gas stations, convenience stores, and a multitude of other applications. In general, the illuminated sign 2 of the present invention includes a transparent front panel 10 interconnected to a transparent rear panel 8 and which includes one or more lights positioned therein. The lights are generally powered by a solar panel 4 although batteries may be used for the same purpose. The transparent front panel 10 and transparent rear panel 8 are sized in one embodiment of the present invention to be interconnected to a standard real estate frame 6 and thus be interchangeable with existing framework. Furthermore, based on the geometry of the transparent front panel 10 and transparent rear panel 8, a sign internal cavity is created which provides space for electronic componentry and other devices which may be included.

Furthermore, as shown in the drawing in FIG. 1, sign indicia 42 may be printed on either the transparent front panel 10 or the transparent rear panel 8 and may include any type of message, and include lighting in alternative embodiments of the present invention. The indicia may be molded into the front and rear panels, applied with stickers or alternatively painted or printed on the exterior surface of the panels. In general, the transparent front panel 10 and transparent rear panel are comprised of a polycarbonate material or other plastic, but which may include polyvinyls, polypropylene, fiberglass, and other materials well known in the art but which are generally transparent to allow the transmission of light.

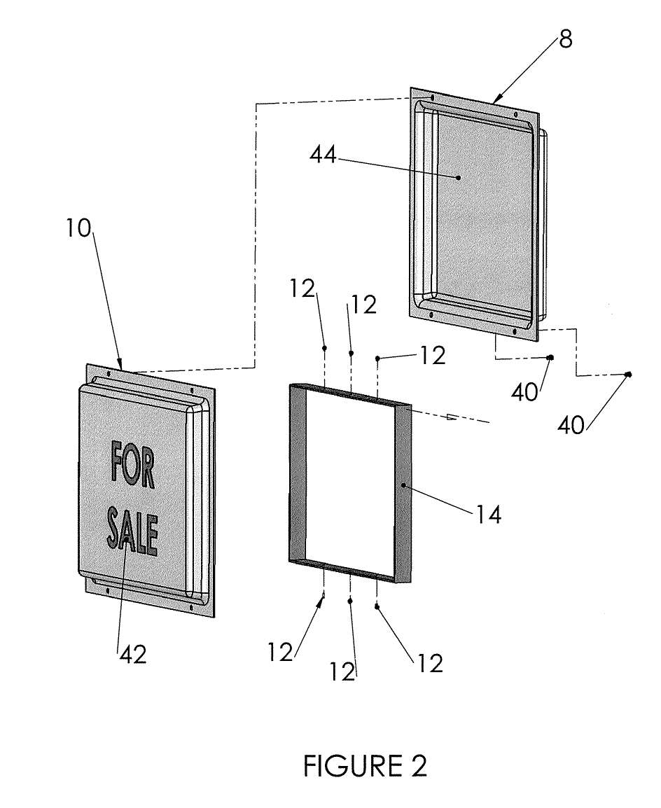

Referring now to FIG. 2, an exploded view of the illuminated sign 2 shown in FIG. 1 is provided herein with the frame removed for clarity. As depicted in FIG. 2, the sign generally includes the transparent front panel 10 and a transparent rear panel 8 which is interconnected to the front panel 10 with attachment hardware 40 such as screws, bolts, or other similar devices. The transparent front panel 10 and transparent rear panel 8 in one embodiment defines a sign internal cavity 44 which includes sufficient space to include a wiring harness 14 which interconnects one or more light bulbs 12 to the power source provided by either a solar panel 4 or battery pack as shown in FIG. 1. Although the light bulbs 12 are generally comprised of light low voltage LEDs, other types of lights requiring any combination of voltage or current may be utilized for the same purpose. Furthermore, in alternative embodiments of the present invention the lighting may be positioned on an exterior portion of the front panel 10, rear panel 8, or positioned along the frame 6. Preferably, the transparent front panel 10 and transparent rear panel 8 are formed so that they create a water tight seal to prevent the penetration of water, snow, and other elements which could be detrimental to the effectiveness of the lighting and/or internal electronic componentry.

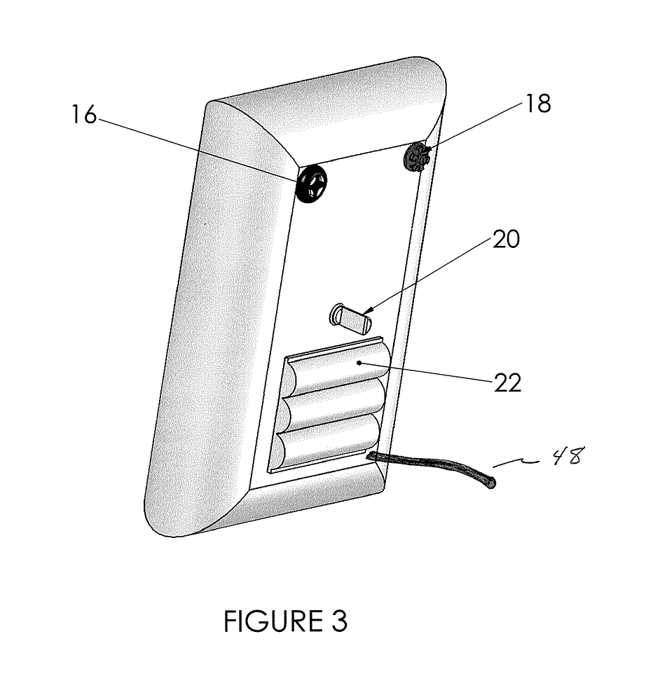

Referring now to FIG. 3, a rear perspective view of the solar panel 4 and solar panel housing are provided herein. More specifically, the solar panel includes a panel of light sensitive material which converts solar energy to electrical energy which is used to charge one or more batteries 22. One example of the solar panel is a Bell Howell Model E5923. The batteries in turn provide electrical current via an electrical conduit 48 to the light bulb 12 positioned within the illuminated sign 2. Batteries such as Sanyo 900 mah nimh rechargeable batteries may be used as ell as other similar devices well known in the art. Furthermore, the solar panel framework may be interconnected to the frame by the use of the mounting post 20 or other attachment hardware 40 to provide a secure positioning of the solar panel and which may be adjustable to allow for optimum orientation with the sun based on the time of the year.

Furthermore, as shown in this embodiment a speaker 16 may be included with a light timer 18 and which may further include a vibration/anti tampering sensor 46, and a motion sensor 30 wherein an audible signal may be used if there is excessive tampering. Furthermore, the timer may be used to turn the lights on and off at predetermined times and to provide additional flexibility for neighborhoods where neighbors may not want the sign illuminated throughout the entire evening. One example of such a timer is a Fuji miniature timer relay ST7 series. Further, a dimmer switch may be provided to adjust the amount of illumination from the lights. The motion sensor may further utilize in conjunction with the speaker 16 to provide a predetermined voice message to anyone approaching the sign such as a greeting, instructions on how to use the sign, and any other form of information which the user may want. For example, the pre-recorded message may give instructions on inserting a data transmission device such as a flashcard, or providing instructions how to transfer data from an internal memory card or chip provided in the sign.

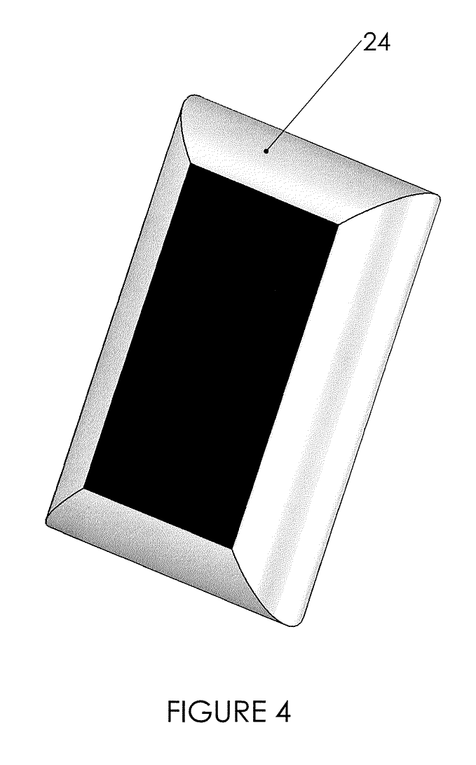

Referring now to FIG. 4, a front perspective view showing one solar panel of the present invention is provided herein. In this embodiment, the solar panel is positioned within a sturdy polycarbonate frame and generally has a size of between about 4-18 square inches, although depending on the electronic componentry positioned within the illuminated sign the size and power of the solar panel may vary. In general, the solar panel is constructed in a manner to generate between about 1.5-15 volts during normal use, and between about 5 mA and 5 amps.

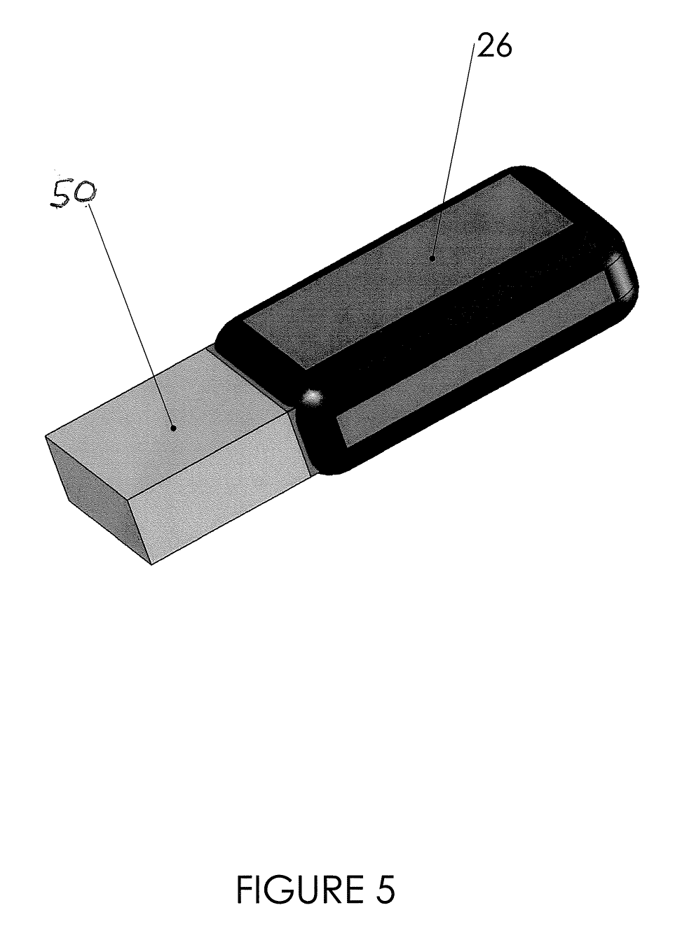

Referring now to FIG. 5, a typical memory card or chip 26 is provided herein or what is commonly referred to as a flash card such as a sandisk gig stick. The front end of the memory card 26 includes a male connector 50 which is used for the interconnection into an access port 20 on the solar panel framework. In this manner, prerecorded data can be stored in a memory card or chip positioned on the illuminated sign 2, and can then be transferred via the memory card or chip 26 to an electronics device such as a PDA, cellphone, laptop computer, or other personal device which is capable of storing and downloading information.

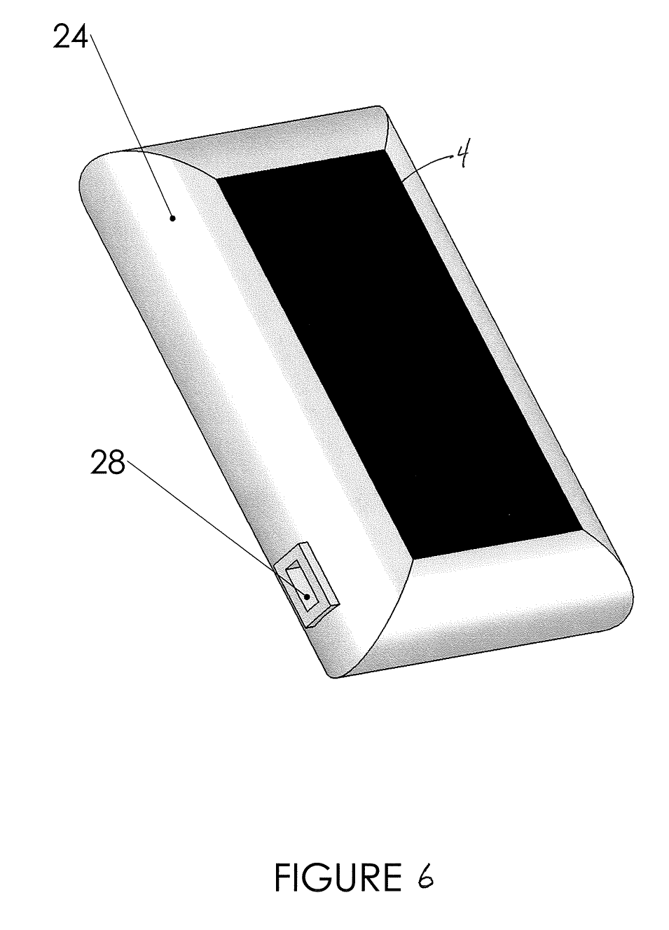

Referring now to FIG. 6, an alternative view of the solar panel 4 of the present invention is provided herein. More specifically, an access port 28 is provided which is used in conjunction with the memory card or chip 26 shown in FIG. 5. As appreciated by one skilled in the art, the access port 28 may include any variety of access ports such as a USB port, or other data transmission means which allows data to be transferred from a memory card or chip 26 to an electronics device such as a PDA, cellphone or laptop computer. For example, if a person is interested in obtaining stored information downloaded in the sign, they would approach the sign at which point a greeting may instruct the user to insert a memory card 26 or USB cable (Universal Serial Bus) into the access port 28. It may further provide instructions on where the access port is provided, and it may allow for the user to directly download information into a laptop computer, flash drive, or other device. Alternatively, the access port 28 may be eliminated and the information be transmitted wirelessly which would eliminate the need for any access port 28.

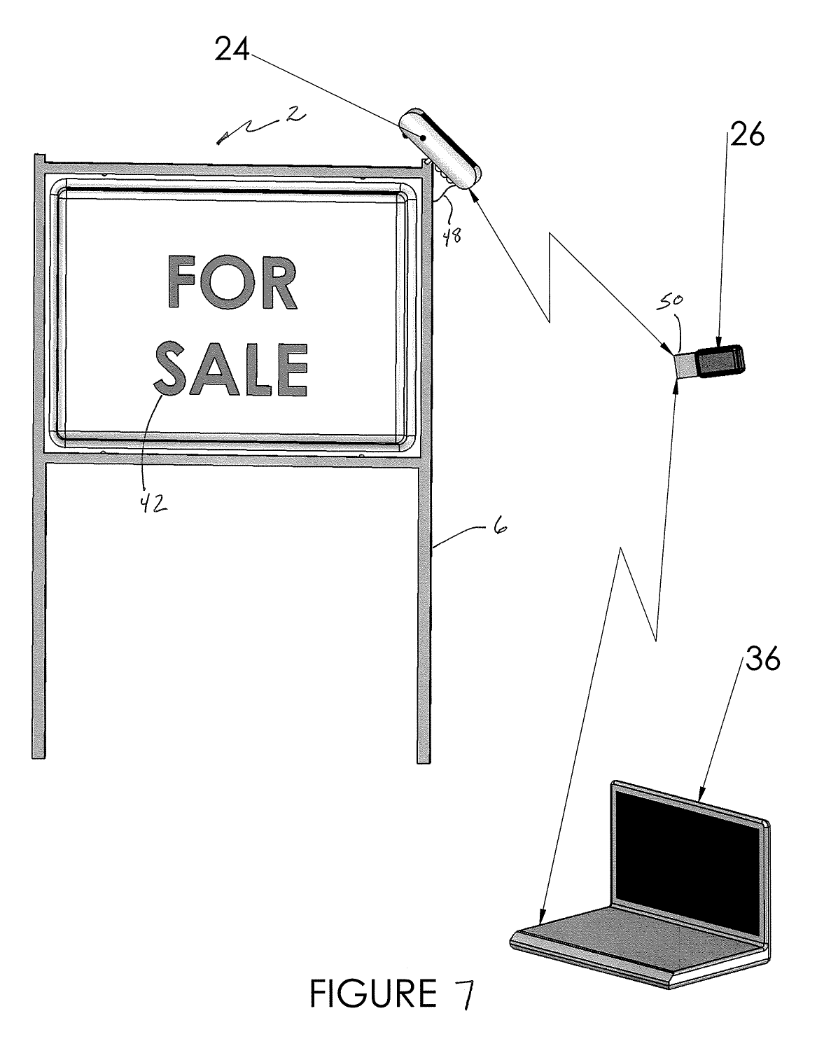

Referring now to FIG. 7, a perspective view of one embodiment of the present invention is provided herein and which more specifically depicts the illuminated sign 2, the solar panel frame 24, and the sign positioned on a frame 6. The memory card or chip 26 is shown as the communication link between the microchip or computer hard drive 52 positioned with the solar panel frame 4 and the notebook computer, handheld PC 36 or other electronic device. As appreciated by one skilled in the art, the sign may or may not be illuminated, may be any size or shape, and may be either portable or non-portable.

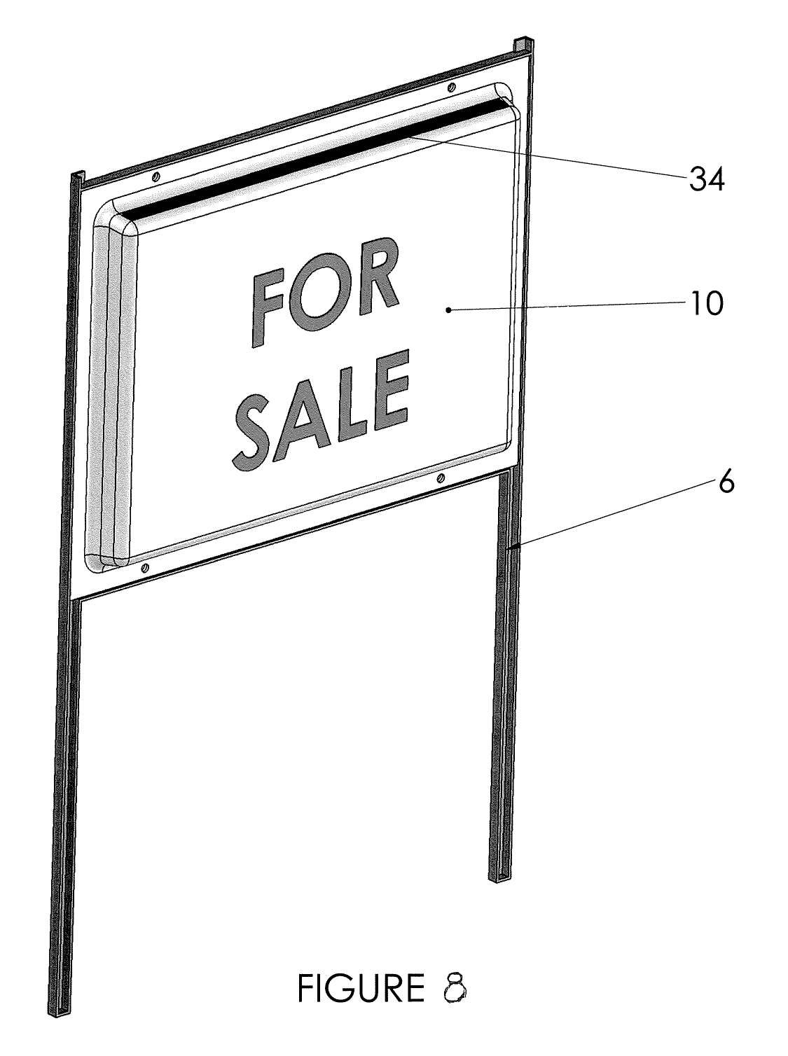

Referring now to FIG. 8, an alternative embodiment of the present invention is provided herein whereas the solar panel 4 is comprised of a flexible solar panel strip as depicted in number 34. By utilizing this embodiment of the invention, the solar panel frame 24 can be eliminated to help eliminate tampering or theft, and the batteries and other componentry stored within the sign cavity 44 for concealment. In the embodiment shown in FIG. 8, the electrical wiring and internal componentry are required for utilization of the device as provided generally within the sign internal cavity 44. Furthermore, a window or other mode of access may be provided in the front panel, rear panel or top or bottom portion of the sign to allow access to the electronic componentry and to allow for adjustments.

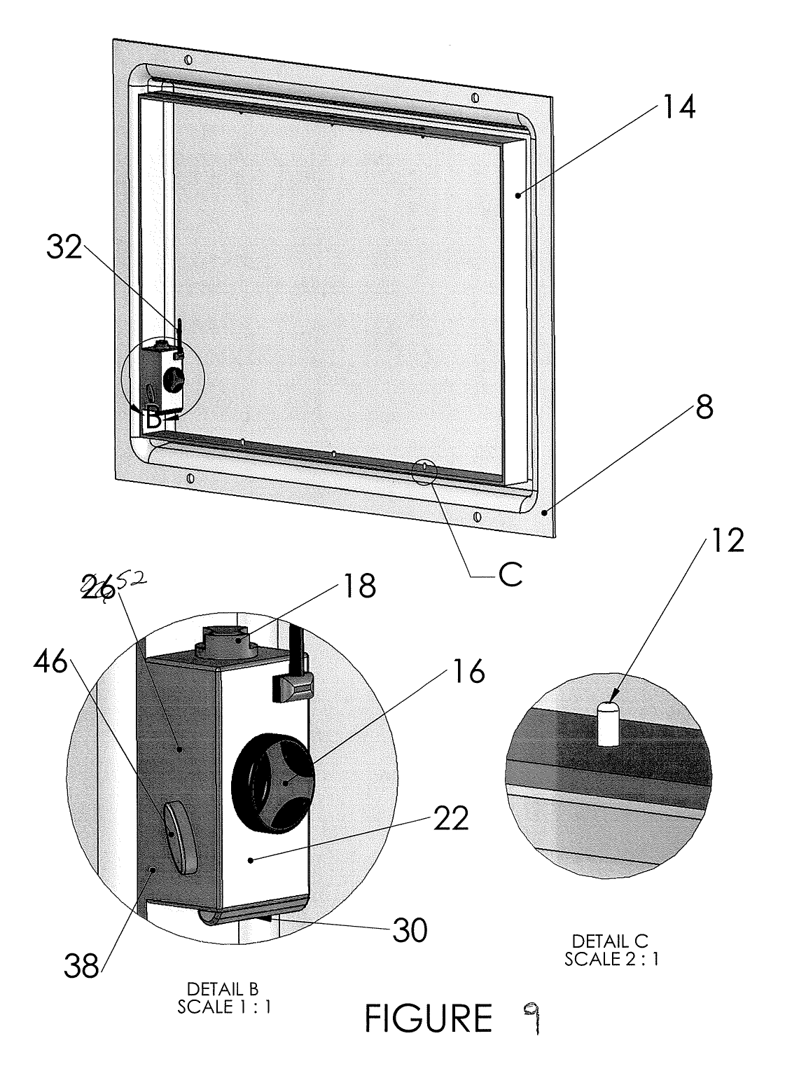

Referring now to FIG. 9, one embodiment of the present invention is provided herein wherein the transparent front panel 10 has been removed for clarity. As shown in this embodiment, and more specifically in detail B, an internal electronic device is provided which includes a microchip or computer hard drive 52 which is used to store programmable data. Thus, any data related to a sale of a house, a realtor, a broker, may be selectively entered, stored and periodically changed while allowing a potential purchaser to download this information if there is an interest in the house being sold. As further included in detail B, a speaker 16 may be provided along with a motion sensor 30 and light timer 18. Furthermore, a vibration/anti-tampering sensor 46 may be included which will detect abnormal vibration, wherein an audible message may be played through the speaker 16 to prevent theft or inadvertent removal.

Furthermore, a wireless transmitter 32 is shown which may be used to transport any data stored in the microchip or computer hard drive 52 to an electronics device such as a cellphone, laptop computer, PDA, or other device capable of receiving and storing information. As further shown in detail C of the FIG. 9, one example of an LED light bulb 12 is provided which extends along the interior cavity of the sign. As appreciated by one skilled in the art, the illuminated bulbs 12 may be used in various color combinations, be programmed to blink or may even be used in certain patterns to convey a message or otherwise obtain the attention of a potential user. Furthermore, the intensity of the light in one embodiment can be selectively adjusted with a dimmer switch to assure that the lights are not illuminated to brightly in certain residential areas. With regard to the embodiment shown in FIG. 9, it is anticipated that an additional access port 28 would be provided to allow access to a memory card or chip 26, and would be positioned where a portion may extend beyond the transparent front panel 10 for access, and to allow the motion sensor 30 to identify any motion from someone approaching the sign.

In another embodiment of the present invention, it is anticipated that the data stored in the microchip or computer hard drive 52 is information related to the sale of real estate such as a residential house, commercial property, machinery or any other commodity available for sale. This data may also include information related to a realtor, data related to the house or apparatus which would include numerous photographs, digital images and a tour of a property for example which could be easily downloaded on a personal computer or other electronics device such as a PDA (Personal Digital Assistant), cell phone, etc. Furthermore, the data may include contact information for a realtor, local businesses and services such as mortgage brokers, construction companies, banks, yard services, and any other practical information which may be useful in a sales transaction. Furthermore, contact information which would be helpful in arranging a personal tour of the house may be obtained. One advantage of the present invention is that prospective home buyers can eliminate the necessity of having to arrange a personal tour of the property with a realtor since they will be able to download significant amounts of information and detail than is possible or even conceivable with existing real estate signs and fliers associated therewith. After reviewing numerous houses, the prospective home buyer could narrow their selection to a few different properties after downloading the information and conducting their own due diligence regarding interest in the property after seeing a virtual tour and additional details regarding the prospective house or device to be purchased.

It is a further aspect of the present invention that the downloaded information would include advertising that would be sold to local merchants and web providers. For example, a bank or mortgage broker would pay a certain fee to include their information included in the data stored within the illuminated sign, as well as advertising or links which would interconnect a user immediately to the mortgage banker, realtor, or other paraprofessionals involved in the transaction. Thus, the data base providing the information related to the house or other sale can include a variety of advertisements, as well as other prospective properties within the same price range to not only save time on behalf of the prospective buyer but also to alert realtors of serious buyers within a given price range or geographic area. It is anticipated that the information could be used in conjunction with the standard MLS (multiple listing service) listings used by realtors, and could provide the same type of information regarding a sales transaction.

While various embodiments of the present invention have been described in detail, it is apparent that modifications and alterations of those embodiments will occur to those skilled in the art. However, it is to be expressly understood that such modifications and alterations are within the scope and spirit of the present invention, as set forth in the following claims.

What is claimed is:

1. A portable, solar powered illuminated sign, comprising:
a sign comprising a front surface operably interconnected to a rear surface and defining a space therebetween, at least any of said front and said rear surfaces adapted for displaying indicia;
a frame operably interconnected to said sign;
a solar panel operably interconnected to at least one of a said sign and said frame which converts solar energy to electrical energy;
a battery in operable communication with said solar panel;
at least one illuminating device positioned in said space and which is in operable communication with said battery; and
a memory storage device which is in operable connection with said battery and which is adapted to store data related to a sales transaction.

2. The portable sign of claim 1, further comprising a dimmer switch in operable communication with said at least one illuminating device, wherein the amount of illumination of said sign can be selectively adjusted.

3. The portable sign of claim 1, further comprising a timer operably interconnected to said illuminating device which turns on said illuminating device only during a predetermined time period.

4. The portable sign of claim 1, further comprising a portable flash drive adapted for operable interconnection with said memory storage device to download and transfer the data stored on said memory storage device.

5. The portable sign of claim 1, further comprising a motion sensor in operable communication with said battery which sends a signal to a recorded message upon detection of motion proximate to the portable sign.

6. The portable sign of claim 1, wherein said front surface and said rear surface of said sign are comprised of at least one of a polycarbonate, a polyvinyl, a plastic, a fiberglass and a nylon.

7. The portable sign of claim 1, further comprising a transmitter operably interconnected to said memory storage device, wherein data can be transmitted wirelessly to an electronics device.

8. The portable sign of claim 7, wherein said electronics device comprises at least one of a laptop computer, a handheld computing device and a cellular phone.

9. The portable sign of claim 1, further comprising an access port interconnected to said memory storage device which is adapted to receive a device capable of transferring data.

10. A solar powered illuminated sign capable of storing and transmitting data, comprising:
a sign having a front surface, a rear surface and indicia provided on at least one of said front and rear surface;
a frame operably interconnected to said sign;
a solar panel operably interconnected to at least one of said sign and said frame which is capable of converting solar energy to electrical energy;
an energy storage device in operable interconnection with said solar panel to store electrical energy;
a data storage device interconnected to said energy storage device which is capable of storing electronic data; and
at least one illuminating device in communication with said energy storage device and interconnected to at least one of said frame and said sign which is operably positioned to illuminate said sign.

11. The sign of claim 10, wherein said front surface and said rear surface are operatively interconnected to define a space therebetween to receive said at least one illuminating device.

12. The sign of claim 10, wherein said energy storage device is a battery.

13. The sign of claim 10, wherein said data storage device is at least one of a microchip and a programmable computer hard drive.

14. The sign of claim 13, wherein said data storage device further comprises an access port adapted to receive a data transfer means.

15. The sign of claim 13, wherein said data transfer means comprises a flash drive, a laptop computer, a handheld electronics device and a cell phone.

16. The sign of claim 13, wherein said receiving port comprises at least one of a USB port, an ethernet port, a port for receiving a telephone line, a floppy disc port and a zip drive port.

17. The sign of claim 10, further comprising a transmitter in operable communication with said data storage device, wherein said electronic data may be transmitted wirelessly to an electronic device.

18. A method for providing information from a portable sign, comprising:
providing an illuminated sign operably interconnected to a frame;
illuminating said sign when the amount of ambient light falls below a predetermined level;
providing a data storage device which is operably interconnected to at least one of said illuminated sign and said frame;
storing predetermined data on said data storage device;
providing a port operably interconnected to said data storage device which is adapted to receive a data transfer device; and
transferring said predetermined data to said data storage device upon insertion of said data transfer device into said port.

19. The method of claim 18, wherein said predetermined data comprises information related to a sale of a home, advertising data, realtor data and contact information.

20. The method of claim 18, wherein said data transfer device comprises a flash drive, a personal computer, a PDA, a cellular phone and a floppy disc.

21. The method of claim 18, further comprising transmitting an audio signal upon detecting motion within a certain distance from said sign.
